(19) United States
(12) Patent Application Publication
(10) Pub. No.: US 2006/0010020 A1
(43) Pub. Date: Jan. 12, 2006

(54) Non-stale incremental planning

(76) Inventors: Ranjit Notani, Southlake, TX (US); Peng Zhao, Irving, TX (US); Mark B. Whipple, Flower Mound, TX (US); Ken McAloon, Charlotte, NC (US)

Correspondence Address: HOWISON & ARNOTT, L.L.P, P.O. BOX 741715, DALLAS, TX, 75374-1715, US

(21) Appl. No.: 10/887,468

(22) Filed: Jul. 8, 2004

(51) Int. Cl. G06Q 99/00

(52) U.S. Cl. 705/7

(57) ABSTRACT

Exemplary methods and systems of the invention include a value chain management program that uses the most current, up-to-date data to re-plan a value chain. The value chain management program of the invention is an event-driven solution that updates the data in the value chain whenever a change in state of the value chain occurs or an exception occurs, resulting in the most recent data being used. Moreover, the value chain management program is able to identify and process only the portion of the value chain that is affected by the state change, or the exception instead of the entire value chain, thereby reducing processing time tremendously. The value chain management program then uses the up-to-date value chain data to determine whether any changes are needed to the affected portion of the value chain plan.

### FIELD OF THE INVENTION

The present invention relates to enterprise value chain logistics planning and, more particularly, to methods and systems for optimizing the planning and execution of a value chain.

### BACKGROUND OF THE INVENTION

In an increasingly global economy, business enterprises of all types are faced with the challenge of managing and optimizing ever more complex supply chains. These supply chains, often called “value chains,” are characterized by a high degree of collaboration, cooperation, and interdependency between the enterprise and other entities or partners in the chain (e.g., raw materials producers, component manufacturers, distributors, and the like). The business goal of managing and optimizing a value chain is to minimize the costs incurred by all participants in the chain while maintaining a high level of customer service and maximizing profits. In order to achieve this goal, the enterprise strives to reduce the quantity of stored goods in the value chain, while minimizing opportunity loss by maintaining a sufficient inventory level to satisfy customer demand.

To meet customer demand, an enterprise forecasts the demand of the future and creates a plan of the movement and placement of the inventory to meet the customer demand. This plan typically includes a plurality of actions that need to be taken to maintain the inventory at a certain level while maximizing customer service level. An important aspect of managing the value chain is the execution of this plan. However since the value chain can be complex and may involve multiple partners, unexpected events and contingencies often occur that adversely impact the inventory levels and the ability of the enterprise to meet demands. For example, a delivery truck may break down causing an interruption in supply, or a storm may cause a large unexpected rise in demand for construction materials. These unexpected events hereinafter referred to as “exceptions,” cause the state of the value chain to deviate from the existing plan. The deviation may be an increase or decrease in inventory at various locations for various items and/or an inability to meet customer demand.

In the previous art, the approach to deal with exceptions is to create a totally new plan for the whole value chain in each batch run. A typical batch run occurs periodically, and considers all value chain changes in creating the new plan. Existing planning and execution systems uses the batch-run approach.

There are some major problems with this traditional approach to planning. Firstly the latency between two planning runs is typically at least a day and could be as long as a week. During this period of time, the state of the value chain is changing. As more changes occur, the planning system has an increasingly more ‘stale’ view of the state of the value chain, and the plan will quickly be rendered useless. [Traditional planning systems may try to reduce the staleness of the data by running the batch plan more frequently. But in reality, since the batch planning system plans the whole value chain at once, it could take a significant amount of time to complete. The frequency of the batch computations is therefore limited by the time required to complete the planning process.

Traditional planning systems take a ‘snapshot’ of the value chain at the beginning of the planning process and compute actions based on that snapshot. Because the plan computation can take a considerable amount of time and today's value chains are highly dynamic, the plan that is produced by the traditional planning system is out of date before the planning process is complete. This is especially prevalent in the near term, and the traditional planning approach becomes ineffective for near term planning and execution.

A new approach is needed that will optimize the value chain when a change in state to the value chain occurs.

### BRIEF SUMMARY OF THE INVENTION

Exemplary embodiments of the invention are directed to methods and systems for managing and optimizing a value chain. Exemplary methods and systems of the invention include a value chain management program that uses the most current, up-to-date data to generate actions to compensate for the exceptions and changes in the value chain. The value chain management program of the invention is an event-driven solution that updates the data in the value chain whenever a value chain state change occurs, resulting in the most recent data being used. Moreover, the new techniques in this invention are able to identify and process only the portion of the value chain that is affected by the state change instead of the entire value chain, thereby reducing processing time tremendously. The exemplary value chain management program then uses the up-to-date value chain data to determine whether any actions or changes are needed to the affected portion of the value chain plan.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates an exemplary enterprise value chain;

FIG. 2 illustrates out-of-date or the staleness of data over time in existing value chain management programs;

FIG. 3 illustrates the up-to-date or non-staleness of data over time in accordance with embodiments of the invention;

FIG. 4 illustrates an exemplary value chain management program according to embodiments of the invention;

FIGS. 5A-B illustrate an exemplary value chain subnet according to embodiments of the invention; and

FIG. 6 illustrates an exemplary flowchart that may be used with the value chain management program according to embodiments of the invention.

FIG. 7 illustrates the customer service level relationship to safety stock and the effects of incremental planning on the relationship.

### DETAILED DESCRIPTION OF THE EXEMPLARY EMBODIMENTS INVENTION

Embodiments of the invention provide a system and method for managing a value chain that uses the most current, up-to-date data that is related to the value chain. A value chain basically has two phases: a planning phase and an execution phase. The planning phase focuses primarily on the logistics of setting up the value chain and addressing both the long-term and short-term needs of the enterprise. The execution phase focuses primarily on carrying out the plan and typically addresses only the short-term needs of the enterprise. Embodiments of the present invention impact both the planning phase and execution phase of a value chain.

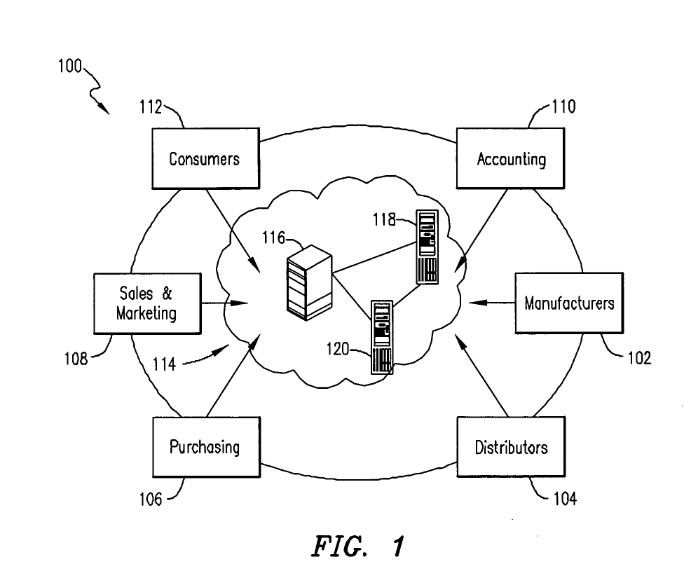

FIG. 1 shows an exemplary value chain 100 (or portion thereof) for a typical enterprise. As can be seen, the value chain 100 includes both external entities, such as manufacturers 102 and distributors 104, as well as entities that are internal to the enterprise, such as purchasing 106, sales and marketing 108, and accounting 110. These entities collaborate and share information with one another to provide value to each other and to the enterprise in various ways that are well-known and need not be described here. In some cases, consumers 112 may also be viewed as part of the value chain 100.

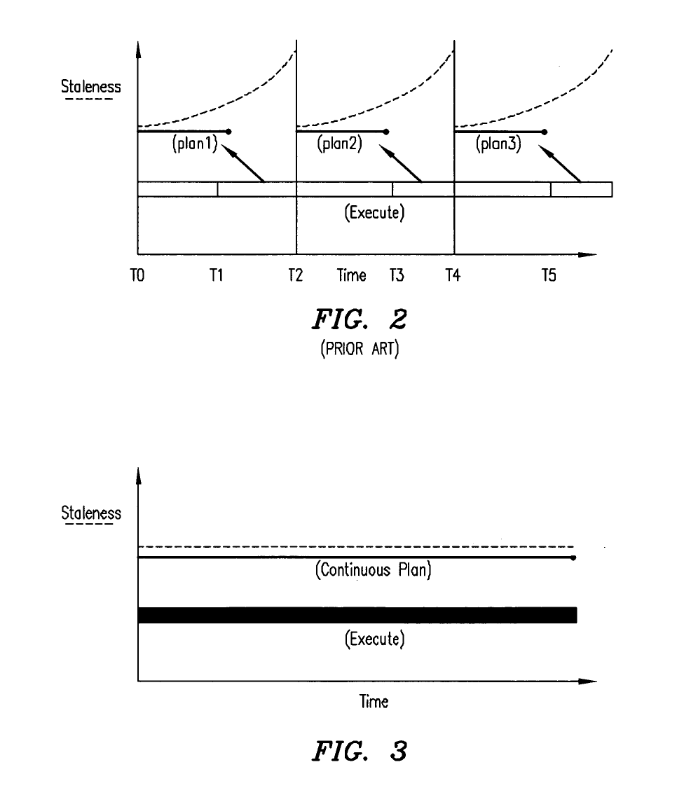

The internal and external entities of the value chain 100 are linked together by a value chain management system 114. Through the value chain management system 114, the enterprise and the entities may share data and information, schedule deliveries, and generally work together to achieve the business goal of minimizing inventory for each entity. The value chain management system 114 may include one or more computers/servers 116, 118, and 120 that typically reside at the enterprise, but may be connected to the external entities over a network (not expressly shown). The computer servers 116-120 store (e.g., on a computer readable medium) and execute a value chain management program that includes various application tools for inventory control, purchasing, accounting, and the like. The value chain management program allows the various entities of the value chain 100 to collaborate with one another and with the enterprise. Due to the size and complexity of most value chains, schedule-driven and batch processing value chain management systems of the prior art often result in stale or out of date data being used. This is illustrated in FIG. 2, where the vertical axis represents staleness and the horizontal axis represents time. Times T0, T2, and T4 represent the start of scheduled planning sessions. At these times, a so-called snapshot of the current state of the value chain is taken and used for each planning session. Times T1, T3, and T5 represent the end of the planning sessions and the start of the execution of the plans that were devised in those planning sessions. The dotted line represents the staleness of the data used during the planning and execution of the plans. As can be seen, when planning starts, the data used is relatively fresh. As planning progresses, however, the data grows exponentially more stale because newer data becomes available, yet the systems are still using the snapshot taken at the start of the planning session. Consequently, the plans are often inaccurate and inefficient.

Accordingly, instead of a system that plans based on a predetermined schedule, embodiments of the invention provide an event-driven value chain management system. An embodiment of the invention starts the planning process upon a change of state event for the value chain. The state change event is related to planned business events such as new transactions (a purchase order arrived for example), or for temporal events (the time to ‘freeze’ forecasts has arrived), or exception events (a stock-out exception occurred). The planning system has the opportunity to optimize the value chain whenever any changes to the value chain occur. The latency of the value chain management system is greatly reduced because the system is event driven and reacts to any changes to the value chain. The number of changes the system must manage during any particular planning run is greatly reduced because the system reacts to value chain state changes rather than waiting for a scheduled batch run to handle all the value chain changes that occurred since the last batch run.

An intelligent execution module will also use the most current transaction data to determine the most optimal value chain state. Traditional planning systems make fixed assumptions about, or use estimates to determine some business constraints. For example, order lead times are typically estimated by traditional planning systems. IXM will use estimates where lead times are not known, but will use actual transaction data when it is available. This gives the planning system a much more accurate ‘non-stale’ view of the value chain. For example, upon creation of new order transactions, IXM will use the estimated order transportation lead time. As the state of the order transaction changes, actual lead times will change. Upon initial creation, IXM enters a desired delivery date using estimated lead time. The seller will then make a promise that he can deliver the order on a particular date. This makes the lead time for the order more accurate (the supplier has provided an expected ship date and expected arrival date). Upon tendering the order for loading, the transaction lead time has become even more accurate (we know the tender date). As the order is shipped, the ship date is known, furthering the accuracy of the lead time. The order will eventually arrive at the buyer's site, and the lead time is exactly know (it has arrived). IXM understands the state of a transaction, and can use the most accurate information (lead times in this case) to arrive at the most optimal state of the value chain. The intelligent execution module uses the most accurate and up-to-date fields of a transaction based on state to provide the most non-stale view of the value chain.

In addition, an exemplary value chain management system performs planning only for the portion of the value chain that is affected by any changes in the value chain rather than for the entire value chain. This type of planning is referred to herein as incremental planning and helps reduce the overall planning cycle time from, for example, hours or days (as in the case of previous systems) to seconds or minutes. Because the time required to run the plan is minimal, the data the system uses is current or non-stale. When a state change event occurs, an exemplary value chain management system of the invention identifies the portion of value chain that is affected by the state changes. The exemplary value chain management system thereafter uses the latest (non-stale) data to determine whether changes to the plan are required, due to the change in state of the value chain.

FIG. 3 illustrates the non-staleness of a value chain management system according to an embodiment of the invention. The chart in FIG. 3 is similar to the chart in FIG. 2 in that the vertical axis represents staleness and the horizontal axis represents time. Rather than operating according to a predetermined schedule, the exemplary value chain management system continuously updates the plan of the value chain each time there is new data. Thus, the data used in planning and executing the value chain is not stale or at least is minimally stale. This helps ensure that the plan is accurate and optimized.

It should be noted that the term “non-stale” as used herein may, but does not necessarily, mean real-time. For example, if a state change occurs, but the data about the state change is not reported for some time, then the data is not real-time. However, that data may be considered to be non-stale if it is the newest or most recent data available about an element of the value chain.

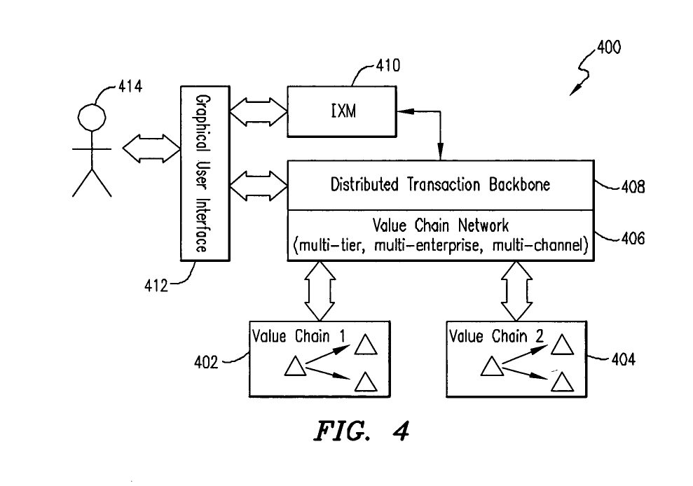

FIG. 4 illustrates the architecture of an exemplary value chain management program 400 according to embodiments of the invention. As can be seen, the value chain management program 400 comprises a number of functional components, including value chain components 402 and 404, which form the foundation layer of the value chain management program 400. The value chain components 402 and 404 contain data pertaining to the various transactions between the enterprise and the entities in the value chains. This transaction data is provided to a value chain network 406, where the data may be shared with the other entities in the value chain. The value chain network 406 may be a multi-tier, multi-enterprise, and/or multi-channel value chain network.

In other words, components 402 and 404 are exemplary value chains or value chain portions. There can be and usually are many such value chains or value chain portions managed by an exemplary value chain management system or program. The component 406, the value chain network, is generally a network of computers, databases, and computational processes that collect and process data from the various value chains and feeds the data into the distributed transaction backbone 408. The distributed transaction backbone 408 uses transaction data to manage the executions of various transactions between entities, organizations, and systems in the value chain. The distributed transaction backbone 408 also generates new transactions as needed or required. The distributed transaction backbone 408 keeps (in storage) all the transactional data and other data related to other components of the value chain management program.

Furthermore, a distributed transaction backbone 408 processes the data from the various types of transactions, including purchase orders, inventory and shipment transactions, as well as custom transactions for unique business processes. Moreover, the distributed transaction backbone 408 is a distributed technology and therefore is capable of uniting traditionally separate applications and communication technologies. Traditionally separate applications and communication technologies that can be united by embodiments of the present invention include, for example, enterprise resource planner (ERPs), value chain systems, and point of sale (POS) systems. For illustrative purposes, the transactions described herein are part of an inventory replenishment plan, although other types of plans and transactions may certainly be used.

An intelligent execution module (IXM) 410 is configured to retrieve the transaction data that is stored and managed by the distributed transaction backbone 408. Also present is a user interface 412 that allows a user 414 (e.g., enterprise employee) to interact with the intelligent execution module 410. The intelligent execution module 410, in general, is a planning engine that includes one or more optimization algorithms for optimizing the value chain. In accordance with embodiments of the invention, when a value chain event occurs (such as a business transaction, or an exception), the intelligent execution module 410 retrieves transaction data pertaining to the portion of the value chain that is affected by the event. In this way, only non-stale incremental data is used by the intelligent execution module 410 in its optimization algorithms. Thereafter, the intelligent execution module 410 identifies the portion of the value chain that is affected by the event. The intelligent execution module 410 then determines appropriate adjustments, if any, to bring the value chain to it most optimized state. The adjustments are then executed by writing the appropriate actions back to the distributed transaction backbone 408. This type of incremental planning helps reduce the amount of planning time that would otherwise be required if the entire value chain had to be planned, and insures that the most non-stale data is used in the optimization process.

To identify the affected portion of the value chain, it is useful to first determine what constitutes a portion of a value chain. In general, any part of the value chain that is less than the entire value chain may be considered a portion of the value chain. In some embodiments, however, a portion of the value chain may be the entities of the value chain that are responsible for providing or delivering a certain product or products to the enterprise under the replenishment plan. Such a portion may be referred to herein as a “subnet.” The value chain may be divided into a plurality of such subnets that interconnect to form the overall value chain. Each subnet includes the entities that are needed to describe the portion of the value chain including transactions, enterprise structures (such as sites, site-lanes, items, transportation equipment, etc), and process related entities (such as state engines and process policies). Ideally, the subnets are independent of one another, but in practice there may be some overlap between subnets (e.g., the same delivery truck may transport several products to the enterprise).

When a value chain state event occurs, the intelligent execution module 410 is alerted to the event by the distributed transaction backbone 408. The intelligent execution module 410 then determines the subnet to which the exception pertains. A subnet may for example, be identified based on the product or products involved in the state change. The intelligent execution module 410 thereafter obtains the latest data for the value chain insofar as the affected subnet is concerned from the distributed transaction backbone 408. The intelligent execution module 410 then uses that data to determine if any of the transactions associated with the affected subnet should be modified, or any new actions taken to optimize the value chain.

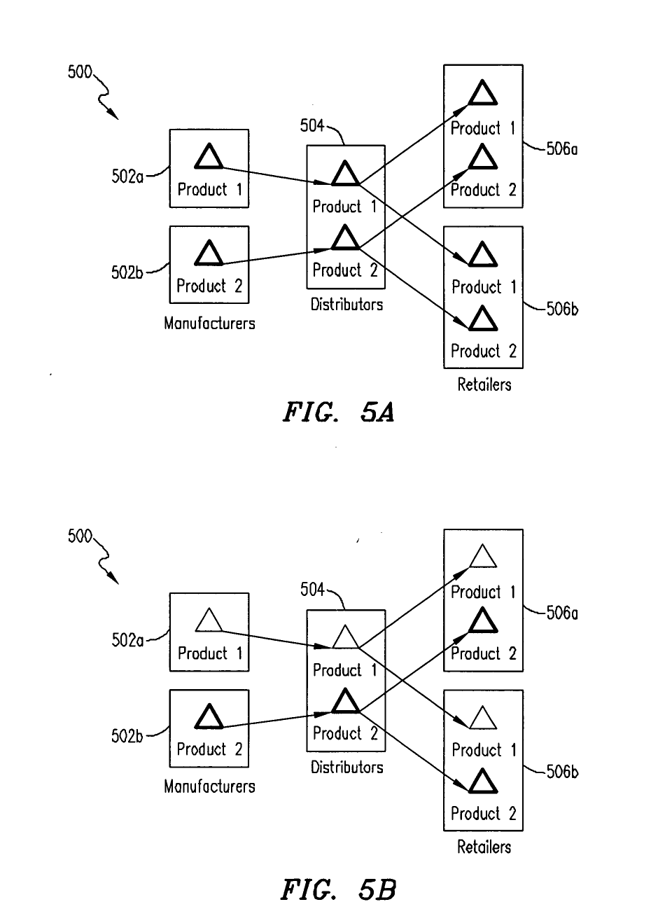

An example of a value chain subnet may be seen in FIGS. 5A-B. In FIG. 5A, a very simplified value chain 500 includes manufacturers 502a-b, distributors 504, and retailers 506a-b. The manufacturers 502a-b produce Products 1 and 2, which are delivered to the distributors 504 and subsequently distributed to the retailers 506a-b. In accordance with embodiments of the invention, the value chain 500 may be divided into a plurality of subnets, each of which may constitute a portion of the value chain 500, as can be seen in FIG. 5B. The subnets are composed of the entities and the systems and transactions associated therewith that are responsible for a particular product or products. In FIG. 5B, for example, the entities that handle Product 1, including the systems and transactions used by those entities, constitute one subnet. A second subnet is responsible for Product 2 being delivered to the retailers 506a-b.

In some embodiments, the same manufacturer 502a or 502b may be responsible for providing multiple products to the enterprise. In that case, the value chain subnet may be based on an individual manufacturer basis as opposed to an individual product basis. Other ways of defining a subnet may also be used without departing from the scope of invention.

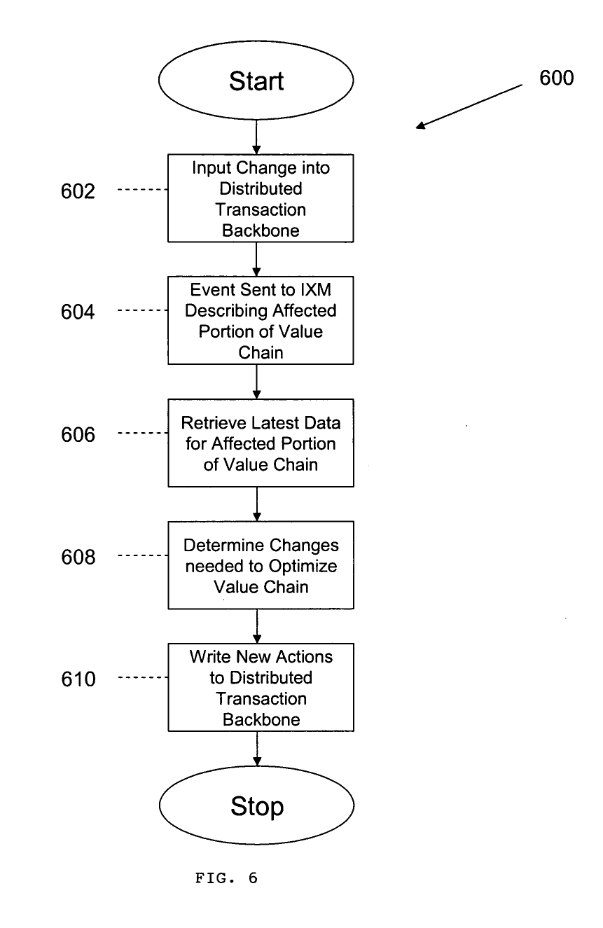

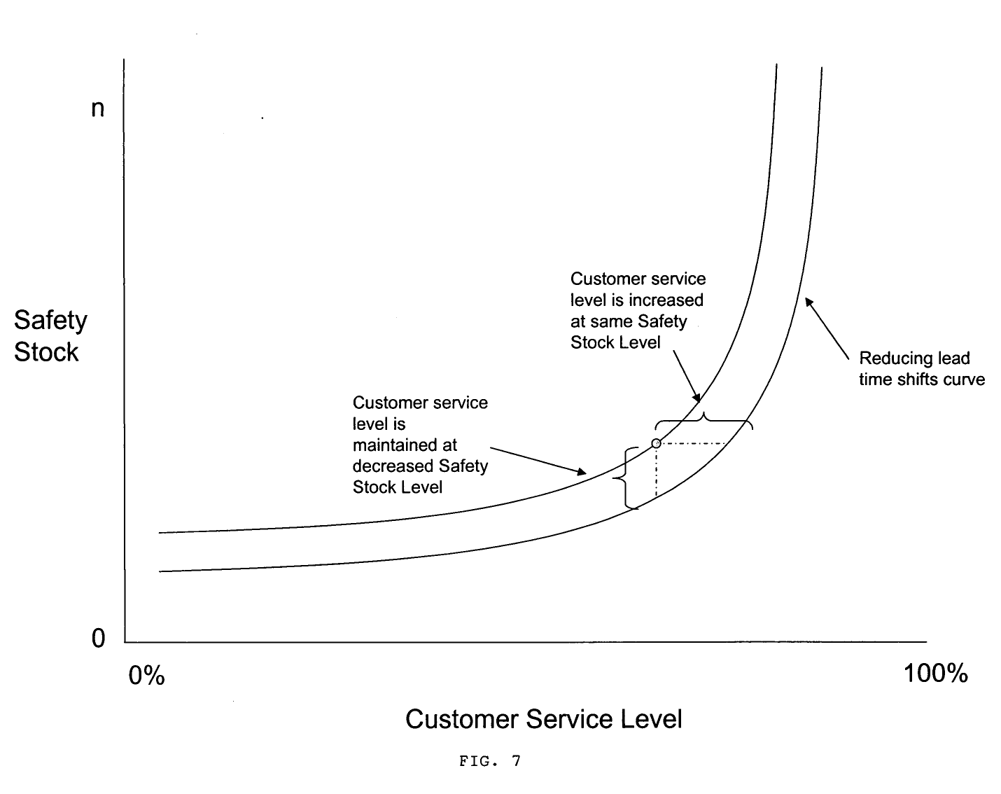

A method 600 of managing a value chain according to embodiments of invention is shown in FIG. 6. As can be seen, when an input 602 is entered into the distributed transaction backbone 408 via the value chain components 402 and 404, an event is triggered 604 alerting the intelligent execution module of a change in the state of the value chain. The intelligent execution module 410 thereafter retrieves the latest data available at step 606 from the distributed transaction backbone 408 for the subnet that is affected by the state change event. The intelligent execution module 410 thereafter determines at step 608 the changes (if any) that need to be made to the value chain with respect to the affected subnet. The intelligent execution module thereafter provides the optimization actions back to the distributed transaction backbone 408 at step 610. These actions may consist of new transactions or modification of outstanding transactions.

FIG. 7 illustrates one of the benefits of incremental planning over traditional batch planning. Exemplary incremental planning leads to shorter lead times for inventory movement than that of traditional planning systems. As indicated in the diagram, customer service levels are directly related to the safety stock on hand and the lead time for inventory movement. As the lead time decreases, the graph shifts down and to the right compared to the longer lead time graph. The same level of customer service can be obtained at lower safety stock levels (therefore lower inventory costs). Optionally, while maintaining the current safety stock level, an increased customer service level will occur. An optimal ratio of economic benefit versus customer service level can be achieved by manipulating the safety stock level. Incremental planning provides more opportunity for economic gain, or customer service level increase due to reduced lead time. While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method of incremental planning in a value chain management system, comprising:
detecting a state change in a value chain of an enterprise;
detecting an exception in a value chain of an enterprise;
retrieving current data for a portion of said value chain affected by said state change or said exception, said current data being more recent than any other data available for said portion of said value chain, said current data also being more accurate than estimated constraint values;
determining whether an adjustment needs to be made to a replenishment plan of said value chain with respect to said portion that is affected by said state change or said exception; and
implementing said adjustment, if any, to said replenishment plan of said value chain.

2. The method according to claim 1, further comprising immediately identifying said portion of said value chain that is affected by said event or said exception after said event or said exception is detected.

3. The method according to claim 1, wherein said step of detecting includes inputting data regarding said event or said exception to said value chain management system upon detection of said event or said exception.

4. The method according to claim 1, wherein said portion of said value chain includes all entities that are associated with a particular product of said enterprise.

5. The method according to claim 1, wherein said portion of said value chain includes all entities that are associated with a particular manufacturer in said value chain.

6. The method according to claim 1, wherein said portion is a subnet of said value chain, said value chain comprising a plurality of subnets, each subnet responsible for a different product of said enterprise.

7. A system for incremental planning in a value chain of an enterprise, comprising:
a graphical user interface;
a computer connected to said graphic user interface, said computer comprising a computer readable medium;
a plurality of instructions wherein at least a portion of said plurality of instructions are storable in said computer readable medium, and further wherein said plurality of instructions are configured to cause said computer to:
detect a state change in a value chain of an enterprise;
detect an exception in said value chain of said enterprise;
retrieve current data for a portion of said value chain affected by said event or said exception, said current data being more recent than any other data available for said portion of said value chain;
determine whether an adjustment needs to be made to a replenishment plan of said value chain with respect to said portion that is affected by said event or said exception; and
implement said adjustment, if any, to said replenishment plan of said value chain.

8. The system according to claim 7, wherein said plurality of instructions are further configured to cause said computer to detect said event or said exception by detecting when data regarding said event or said exception is inputted into said system.

9. The system according to claim 7, wherein said plurality of instructions are further configured to cause said computer to immediately identify said portion of said value chain that is affected by said event or said exception after said event or said exception is detected.

10. The system according to claim 9, wherein said plurality of instructions are further configured to cause said computer to identify said portion of said value chain as including all entities that are associated with a particular product of said enterprise.

11. The system according to claim 9, wherein said plurality of instructions are further configured to cause said computer to identify said portion of said value chain as including all entities that are associated with a particular manufacturer in said value chain.

12. The system according to claim 9, wherein said plurality of instructions are further configured to cause said computer to identify said portion as a subnet of said value chain, said value chain comprising a plurality of subnets, each subnet responsible for a different product of said enterprise.

13. A method of managing a value chain of an enterprise, comprising:
detecting a state change in said value chain of an enterprise;
detecting an exception in said value chain of said enterprise;
retrieving non-stale data for said value chain;
adjusting a replenishment plan of said value chain as needed based on said non-stale data, said adjusting including making incremental changes to said replenishment plan; and
implementing said adjustments, if any, to said replenishment plan of said value chain.
